(19) United States
(12) Patent Application Publication
(10) Pub. No.: US 2007/0209827 A1
(43) Pub. Date: Sep. 13, 2007

(54) Connecting Bar Arrangement for an Electric Switch and Electric Switch Comprising a Connecting Bar Arrangement

(76) Inventor: Michael Kruschke, Schwante (DE)

Correspondence Address: HARNESS, DICKEY & PIERCE, P.L.C., P.O.BOX 8910, RESTON, VA, 20195, US

(21) Appl. No.: 10/573,826

(22) PCT Filed: Sep. 17, 2004
(86) PCT No.: PCT/DE04/02120

§ 371 Date: Jan. 16, 2007

(30) Foreign Application Priority Data
Sep. 30, 2003 (DE) 103 46 361.5

(51) Int. Cl. H01B 5/02

(52) U.S. Cl. 174/126.1

(57) ABSTRACT

A connecting bar arrangement for an electric switch is disclosed. The arrangement includes aligned connecting bars. An electric switch is further disclosed, especially a low-voltage power switch including the type of connecting bar arrangement. A localized reduction of the cross-sectional area of at least one of the connecting bars for localized compression of current lines in the direction of alignment is provided in order to act against the Kelvin effect, especially to prevent, more particularly, an increased use of contact pieces based on the removal of switching contacts. Recesses in the form of slots are arranged in external areas, close to the front surfaces. The recesses are parallel to the front surfaces and extend in a transversal manner in relation to the direction of alignment over the surface of each respective connection bar.

This application is the national phase under 35 U.S.C. § 371 of PCT International Application No. PCT/DE2004/002120 which has an International filing date of Sep. 17, 2004, which designated the United States of America and which claims priority on German Patent Application number 103 46 361.5 filed Sep. 30, 2003, the entire contents of which are hereby incorporated herein by reference.

### FIELD

The invention generally relates to a connecting bar arrangement for an electric switch comprising aligned connecting bars. The invention also generally relates to an electric switch, for example a low-voltage power circuit breaker, comprising such a connecting bar arrangement.

### BACKGROUND

In low-voltage power circuit breakers, in particular for high rated currents (for example 6300 A), there is considerable current displacement in switching contact systems of closely adjacent switching poles owing to the connecting bars influencing one another. This current displacement brings about a nonuniform distribution of the current (and thus of the lines of force) over the cross-sectional area of the connecting bars; to be precise in particular when subjected to a surge current. This results in the switching contacts associated with one another being lifted off and correspondingly in considerable erosion of the switching pieces of the switching contacts.

A generic connecting bar arrangement and an electric switch including such a generic connecting bar arrangement are known, for example, from the document DE 100 54 497 A1. In this case it is known that current displacement (skin effect and proximity effect) results in the connecting bars as a function of the localized position of the connecting bars and their phase angle. In order to counteract the effects of this current displacement, in particular in connecting bars which are aligned very closely next to one another, provision is made in the case of this known electric switch for higher contact forces to be applied to movable switching contacts in the form of contact levers which are associated with outer (in the direction of alignment) contact regions of the switching pieces of the connecting bars than are applied to contact levers which are associated with the central contact regions of the switching pieces of the connecting bars. The contact-lifting forces, which are stronger at the outside owing to the higher concentration of lines of force, are thus counteracted.

### SUMMARY

At least one embodiment of the invention includes an object of reducing or even counteracting at least one of these effects of current displacement in another manner. In accordance with at least one embodiment the invention, an object may be achieved by the fact that a localized reduction in the cross-sectional area of at least one of the connecting bars is provided for the localized compression of the lines of force in the direction of alignment.

Such a design makes it possible to deflect the current locally out of regions having the greatest current concentration into regions having the greatest current displacement. This deflection results in an extension of the current paths in the regions having the greatest current concentration and thus in a weakening of the concentration of the current in these regions. The localized reduction in the cross-sectional area therefore brings about compensation of the current distribution over the cross section of the connecting bar; to be precise in particular in a section of the connecting bar which directly adjoins the section having a reduced cross-sectional area, when viewed in the direction of flow.

A connecting bar arrangement is known per se, in which end faces of the connecting bars run parallel to the direction of alignment, and in which the connecting bars are provided with at least one cutout, which runs essentially parallel to the end faces, for the purpose of deflecting the current (DE 101 44 440 C1). With this known connecting bar arrangement, however, the cutouts are provided for the compression of the lines of force transversely with respect to the direction of alignment in order to guide the current close to the end faces provided with switching pieces (stationary switching contacts) parallel to the end faces and thus parallel to the current in associated movable switching contacts, i.e. in order to achieve an attracting effect between the switching contacts.

In contrast to this, with the connecting bar arrangement according to at least one embodiment of the invention, provision may be made for the at least one cutout to extend transversely with respect to the direction of alignment through the entire at least one of the connecting bars.

The phase angles of the aligned connecting bars are generally offset such that, in the outer (in the direction of alignment) sections of the connecting bar, there is a higher concentration of the lines of force, i.e. a higher current load. It is therefore advantageous, in at least one embodiment, if the at least one cutout is provided in a first, outer (in the direction of alignment) region of the at least one of the connecting bars or if, in addition, a second cutout is provided in a second, outer region, which is opposite the first region, of the at least one of the connecting bars.

It is advantageous if the at least one cutout extends close to the end face. This ensures that the lines of force, owing to the current displacement (skin effect and proximity effect), do not concentrate in the two outer (in the direction of alignment) regions of the connecting bar again until the end face is reached.

Particularly effective compensation of the current distribution can be achieved if the at least one cutout extends in the direction of alignment essentially over a quarter of the at least one of the connecting bars.

The novel connecting bar arrangement is preferably provided in electric switches, in particular low-voltage power circuit breakers, in which the connecting bars of individual poles are arranged closely adjacent to one another.

### BRIEF DESCRIPTION OF THE DRAWINGS

One example embodiment of the invention is illustrated in FIGS. 1 and 2, in which:

FIG. 1 shows a schematic illustration of an electric switch including a connecting bar arrangement, and

FIG. 2 shows a connecting bar arrangement for a three-pole electric switch.

### DETAILED DESCRIPTION OF THE EXAMPLE EMBODIMENTS

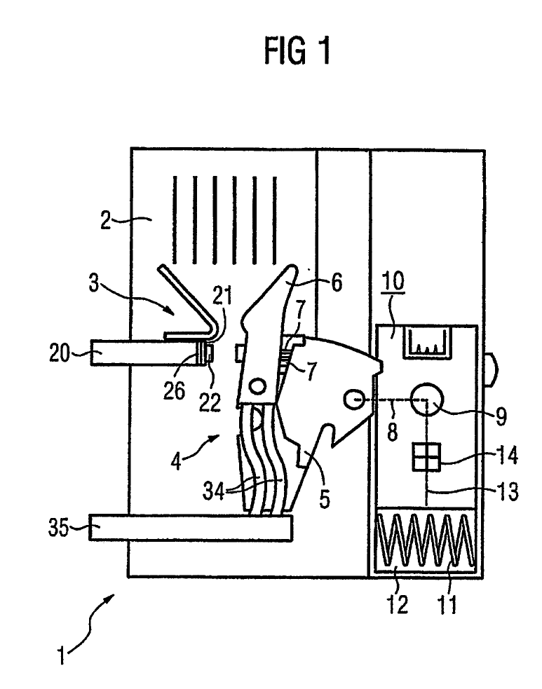

FIG. 1 shows an electric switch 1 in the form of a low-voltage power circuit breaker having a switching contact system and an associated arc-quenching chamber 2. The switching contact system includes a stationary switching contact arrangement 3 and a movable switching contact arrangement 4. The movable switching contact arrangement 4 in this case has a pivotable contact carrier 5 and a plurality of movable switching contacts 6 in the form of contact levers.

The movable switching contacts 6 can be pivoted parallel to one another and are supported on the contact carrier 5 under prestress by way of contact force springs 7. The movable switching contact arrangement 4 is coupled in a known manner to a switching shaft 9 via a first lever arrangement 8 represented merely schematically in FIG. 1.

The switching shaft 9 at the same time is used for driving further switching contact systems, which are not illustrated in any more detail and are arranged parallel to the switching contact system shown. The switching shaft 9 can be moved from an OFF position, in which the switching contact system is open, to an ON position, in which the switching contact system is closed, by way of a drive apparatus 10. When the switching shaft 9 is moved to its ON position, the contact force springs 7 are tensioned further, with the result that their force acts in the pivoting direction of the switching shaft 9 pointing towards the OFF position. The drive apparatus 10 has a drive 12 provided with a storage spring 11, a second lever arrangement 13, which couples the drive 12 to the switching shaft 9, and a switching mechanism 14 for the purpose of latching the movable switching contact arrangements when the switching contact systems are closed or for the purpose of latching the tensioned storage spring 11.

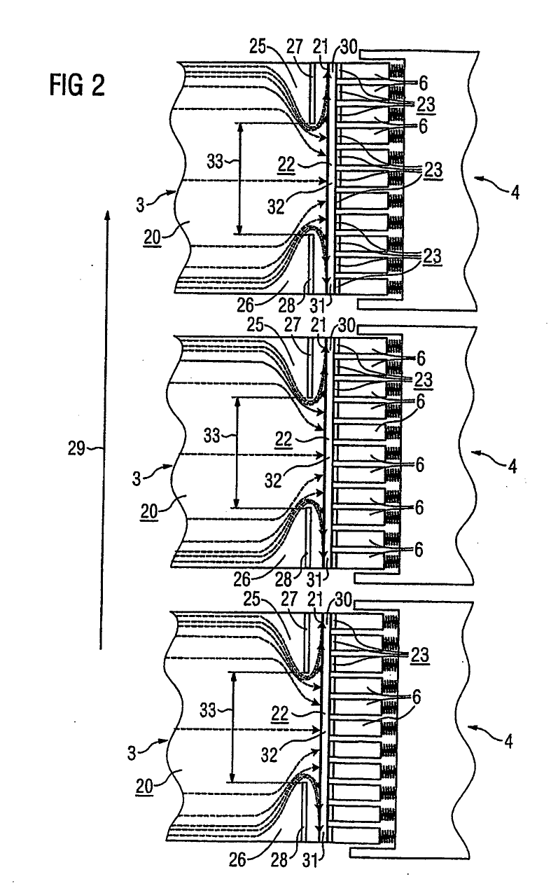

As shown in FIG. 2, three stationary switching contact arrangements 3 form a connecting bar arrangement, which has three aligned, upper connecting bars 20 (cf. FIG. 1). In this case, each of the three connecting bars 20 is provided with switching pieces 22 on their flat end face 21 which faces the movable switching contact arrangement 4, the switching pieces 22 bearing against switching pieces 23 of the movable switching contacts 6 under the force of the contact force springs 7 when the switching contact system is closed.

Each of the connecting bars 20 has two cutouts 27, 28 in the form of slots in the outer (in the direction of alignment) regions 25, 26, the cutouts 27, 28 running close to the end faces 21, parallel to the end faces 21 and extending in each case transversely with respect to the direction of alignment 29 through the entire connecting bar 20. The introduction of these cutouts results in a localized reduction in the cross-sectional area of the connecting bars. Owing to these cutouts 27, 28, the effects of the current displacement are essentially canceled; to be precise owing to the fact that the current distribution is made more uniform. The cross section of the connecting bars is constricted such that the path of the current in the respective connecting bar to the outer (in the direction of alignment) contact regions 30, 31 of the switching pieces of the stationary switching contact arrangements is longer than the path to the central contact region 32 of said switching pieces. The concentration of the current towards the outer contact regions 30, 31 is thus weakened. Flat material made from fiberglass-reinforced plastic has been introduced into the cutouts.

Good results in terms of a compensated current distribution are achieved with the novel connecting bar arrangement if the cutouts 27, 28 of each of the connecting bars 20 have a distance of approximately 8 mm from the respective end face 21 and are in the form of slots having a width of approximately 2 mm, in which case the slots extend in the direction of alignment 29 in each case approximately over a quarter of the width of the connecting bars. The remaining cross section 33 then corresponds approximately to the total cross section of current cables 34 (cf. FIG. 1), which connects the movable switching contacts 6 of the associated movable switching contact arrangement to a lower connecting bar 35 (cf. FIG. 1). Surge current trials, which have been carried out using such a connecting bar arrangement, have shown that, in comparison to conventional connecting bar arrangements, in which no localized reduction in the cross-sectional area of the connecting bars is provided for the localized compression of the lines of force in the direction of alignment, the central contact regions of the switching pieces are utilized more effectively and the outer (in the direction of alignment) contact regions are subjected to a lesser load.

The notches can be produced by sawing or electroerosion. In addition to plate-shaped materials, thermally resistant fillers are also suitable for filling the cutouts.

In place of the slots, closely adjacent drilled holes can also be provided for the localized compression of the lines of force in the direction of alignment, the drilled holes extending in the outer (in the direction of alignment) regions of the connecting bars close to the end sides transversely with respect to the direction of alignment in each case through the entire connecting bar. In this case, it is not necessary for a filler material to be introduced.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A connecting bar arrangement for an electric switch, comprising:
aligned connecting bars,
a localized reduction in cross-sectional area of at least one of the connecting bars being provided for
a localized compression of lines of force in a direction of alignment.

2. The connecting bar arrangement as claimed in claim 1, wherein
end faces of the connecting bars run parallel to the direction of alignment, wherein
the at least one of the connecting bars is provided with at least one cutout, which runs essentially parallel to the end faces, for deflecting the current,
and wherein the at least one cutout extends transversely with respect to the direction of alignment through the entire at least one of the connecting bars.

3. The connecting bar arrangement as claimed in claim 2, wherein the at least one cutout is provided in a first, outer region of the at least one of the connecting bars.

4. The connecting bar arrangement as claimed in claim 3,
wherein
a second cutout is provided in a second region, opposite the first region, of the at least one of the connecting bars.

5. The connecting bar arrangement as claimed in claim 2, wherein
the at least one cutout extends close to the end face.

6. The connecting bar arrangement as claimed in claim 2, wherein
the at least one cutout extends in the direction of alignment essentially over a quarter of the at least one of the connecting bars.

7. An electric switch, comprising a connecting bar arrangement
formed as claimed in claim 1.

8. The connecting bar arrangement as claimed in claim 2, wherein the at least one cutout is provided in a first, outer region of the at least one of the connecting bars, in the direction of alignment.

9. The connecting bar arrangement as claimed in claim 8, wherein a second cutout is provided in a second region, which is opposite the first region, of the at least one of the connecting bars.

10. The connecting bar arrangement as claimed in claim 3, wherein the at least one cutout extends close to the end face.

11. The connecting bar arrangement as claimed in claim 4, wherein the at least one cutout extends close to the end face.

12. The connecting bar arrangement as claimed in claim 8, wherein the at least one cutout extends close to the end face.

13. The connecting bar arrangement as claimed in claim 9, wherein the at least one cutout extends close to the end face.

14. A low-voltage power circuit breaker comprising a connecting bar arrangement formed as claimed in claim 1.

15. An electric switch, comprising a connecting bar arrangement formed as claimed in claim 2.

16. A low-voltage power circuit breaker comprising a connecting bar arrangement formed as claimed in claim 2.
